(19) United States
(12) Patent Application Publication
(10) Pub. No.: US 2007/0066242 A1
(43) Pub. Date: Mar. 22, 2007

(54) System and method for allocating MCS level in a broadband wireless access communication system

(75) Inventors: Byoung-Ha Yi, Seoul (KR); Jang-Hoon Yang, Seongnam-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/523,877

(22) Filed: Sep. 20, 2006

(30) Foreign Application Priority Data
Sep. 20, 2005 (KR) 87364-2005

(51) Int. Cl. H04B 17/00; H04B 7/00; H04B 1/02

(52) U.S. Cl. 455/69; 455/67.11; 455/102

(57) ABSTRACT

A method is provided for transmitting data based on an Adaptive Modulation and Coding (AMC) technique in a Broadband Wireless Access (BWA) communication system. The method includes: measuring a channel quality information (CQI) difference for each of mobile stations (MSs) according to channel information fed back from the MSs; estimating a moving velocity of each of the MSs according to the CQI difference; selecting a mapping table for each individual MS taking into account the estimated velocity of each of the MSs, and allocating the selected mapping table; and transmitting data to a corresponding MS by applying a modulation scheme and a coding rate corresponding to the mapping table.

### PRIORITY

This application claims the benefit under 35 U.S.C. §119(a) of an application entitled “System and Method for Allocating MCS Level in a Broadband Wireless Access Communication System” filed in the Korean Intellectual Property Office on Sep. 20, 2005 and assigned Serial No. 2005-87364, the entire contents of which are incorporated by herein reference.

### BACKGROUND OF THE INVENTION

1. Field of the Invention

The present invention relates generally to an apparatus and method for transmitting/receiving multimedia data in a Broadband Wireless Access (BWA) communication system, and in particular, to an apparatus and method for dynamically allocating resources according to channel characteristics in a BWA communication system.

2. Description of the Related Art

The current mobile communication system has been evolving from the early voice-oriented communication system into a high-speed, high-quality wireless data packet communication system for providing data service and multimedia service. The 3^{rd} Generation mobile communication system, which is now divided into an asynchronous 3^{rd} Generation Partnership Project (3GPP) system and a synchronous 3^{rd} Generation Partnership Project-2 (3GPP2) system, is undergoing standardization for the high-speed, high-quality wireless data packet service.

As an example, the 3GPP system is under standardization for High speed Downlink Packet Access (HSDPA), and the 3GPP2 system is under standardization for 1x Evolution Data and Voice (1xEV-DV).

These standardizations can be considered as a typical effort to find a solution for the high-speed, high-quality wireless data packet service of 2 Mbps or higher in the 3^{rd} Generation mobile communication system. In addition, the 4^{th} Generation mobile communication system aims at providing the higher-speed, higher-quality multimedia service.

In wireless communication, the high-speed, high-quality data service is typically hindered due to the channel environments. The channel environment for the wireless communication undergoes frequent change due not only to white noise, for example, Additive White Gaussian Noise (AWGN), but also to power variation of a received signal caused by a fading phenomenon, shadowing, Doppler effect caused by movement and frequent speed change of a mobile station (MS), interference from the other user and multipath signals, etc.

Therefore, there is a need to efficiently overcome the foregoing hindrances in order to provide the high-speed, high-quality wireless data packet service in the wireless communication. That is, there is a demand for advanced technologies capable of increasing the adaptability for the channel variation in addition to the general technologies provided in the existing 2^{nd} Generation or 3^{rd} Generation mobile communication system. In the existing communication system, active research into an Adaptive Modulation and Coding (AMC) technique is being conducted as a plan to overcome the foregoing hindrances. The AMC technique, a link adaptation technique efficient for data transmission, adaptively changes a data rate rather than the transmission power according to the channel environment, unlike the existing power control technique. A detailed description will now be made of the AMC technique.

The AMC technique adaptively changes a modulation scheme and a coding rate of a channel encoder according to channel variation of a downlink. Channel Quality Information (CQI) of the downlink can be obtained by measuring a Carrier-to-Interference and Noise Ratio (CINR) of a received signal at a receiver of an idle MS. That is, the MS estimates a channel state of the downlink based on the CQI of the downlink, and designates a proper modulation scheme and coding rate of a channel encoder based on the estimated channel state. More specifically, the MS feeds back the CQI of the downlink to a base station (BS) through an uplink. Then the BS estimates a channel state of the downlink using the CQI of the downlink, fed back from the MS. The BS adjusts the modulation scheme and coding rate according to the estimated channel state.

Therefore, a system employing the AMC technique applies a high-order modulation scheme and a high coding rate for an MS having a good channel state. However, the system applies a low-order modulation scheme and a low coding rate for an MS having a poor channel state. Commonly, the MS having a good channel state can be an MS located in the vicinity of the BS, and the MS having a poor channel state can be an MS located in the boundary of the cell or the BS. Compared with the existing technique, which depends on fast power control, the AMC technique increases adaptability for time-varying characteristics of the channel to reduce interference, thereby improving average performance of the system.

Because the AMC technique determines a proper data rate according to channel characteristics before transmission as described above, the transmission power is basically fixed. The data rate is determined depending on a Modulation and Coding Selection (MCS) level. The MCS level is a level for a predefined modulation and channel coding combination. Commonly, a BWA communication system supports various MCS levels by using three modulation schemes of (QPSK) Quadrate Phase Shift Keying, 16-Quadrature Amplitude Modulation (16 QAM) and 64 QAM, and rate-⅓ turbo coding as basic coding.

Generally, the MCS level showing the highest efficiency is selected according to a received CINR of the MS. Therefore, to support the AMC technique, the BS should previously have information on the received CINR of the MS, and the MS uses CQI to deliver its received quality information to the BS.

FIG. 1 is a diagram illustrating a process of applying an AMC technique in a general BWA communication system, and FIG. 2 is a diagram illustrating a concept of a link table according to FIG. 1.

Referring to FIG. 1, in the general AMC application process, a BS 110 generates a preamble signal to be transmitted to an MS 130 in step 101. Thereafter, the BS 110 BPSK-modulates the preamble signal generated differently for each sector, and then transmits the modulated preamble signal to the MS 130 for a first symbol of a downlink frame.

The MS 130 receiving the downlink frame estimates a received CINR from the preamble signal in step 103. Subsequently, the MS 130 encodes the estimated received CINR into 4 or 6-bit information, and then maps/modulates the coded bit information to a CQI value in step 105. Thereafter, the MS 130 transmits the mapped CQI value to the BS 110 for the first three symbols of an uplink frame.

Then the BS 110 demodulates the CQI value received from the MS 130 in step 107. Thereafter, the BS 110 determines an MCS level matched to a CQI value of each MS using a predefined link table in step 109. A concept of the link table will now be described with reference to FIG. 2.

Referring to FIGS. 1 and 2, there is shown a conceptual process of determining an MCS level in the AMC technique. That is, an MCS level capable of acquiring the highest throughput is determined according to a received CINR as shown in FIG. 2. As a result, the throughput located in the outmost place of the bold line 200 in the graph of FIG. 2 is acquired. A CINR range occupied by each MCS level indicates the CINR range where the MS 130 can successfully receive data at a packet error rate (PER) of 1% or below when the BS 110 transmitted the data to the MS 130 after encoding and modulating the data according to a corresponding MCS level. Based on this concept, the BS 110 generates an MCS level mapping function according to CINR with the aim of acquiring the high throughput, and the generated MCS level mapping function is called the link table.

Next, BS 110 selects a corresponding MS to which it will transmit data, according to a predetermined scheduling algorithm in step 111. Subsequently, after selecting a particular MS through the scheduling algorithm, BS 110 transmits data to the selected MS using the modulation scheme and coding rate corresponding to the MCS level in step 113.

As described above, the BWA communication system commonly uses the AMC technique to acquire a high data quality while acquiring high data throughput. In addition to the link table, an MCS level mapping function based on the CINR is used to apply the AMC technique.

In the BWA communication system, channel characteristics suffer a change according to moving velocity of the MS. However, the BWA communication system applies the same MCS mapping table regardless of the moving velocity of the MS. Therefore, if the BWA communication system uses the same MCS mapping table for both a high-velocity MS and a low-velocity MS, the error rate increases.

In order to solve this problem, there is a need for a scheme capable of applying different MCS mapping tables to both a high-velocity and a low-velocity MS according to its moving velocity, for dynamic resource allocation.

### SUMMARY OF THE INVENTION

It is, therefore, an object of the present invention to provide an MCS level allocation system and method for efficiently providing high-speed wireless multimedia service aimed at the next generation mobile communication system.

It is another object of the present invention to provide an MCS level allocation system and method for facilitating efficient utilization of system resources by adaptively applying different environments for every MS in a BWA communication system.

It is further another object of the present invention to provide a system and method for allocating an MCS level taking the velocity of an MS into account in a BWA communication system.

It is yet another object of the present invention to provide a BS system and method for dynamically allocating resources by applying an MCS mapping table according to a moving velocity of each individual MS in a BWA communication system.

According to one aspect of the present invention, there is provided a method for transmitting data based on an Adaptive Modulation and Coding (AMC) technique in a Broadband Wireless Access (BWA) communication system. The method includes measuring a channel quality information (CQI) difference for each of mobile stations (MSs) according to channel information fed back from the MSs; estimating a moving velocity of each of the MSs according to the CQI difference; selecting a mapping table for each individual MS taking into account the estimated velocity of each of the MSs, and allocating the selected mapping table; and transmitting data to a corresponding MS by applying a modulation scheme and a coding rate corresponding to the mapping table.

According to another aspect of the present invention, there is provided a system for transmitting data based on an Adaptive Modulation and Coding (AMC) technique in a Broadband Wireless Access (BWA) communication system. The system includes a mobile station (MS) for feeding back its own channel quality information (CQI), and transmitting/receiving data using a modulation scheme and a coding rate allocated according to its own velocity; and a base station (BS) for measuring a difference of the CQI fed back from the MS, estimating a moving velocity of each MS according to the CQI difference, and exchanging data with the MS using a modulation scheme and a coding rate of a mapping table corresponding to the velocity of the MS.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a process of applying an AMC technique in a general BWA communication system;

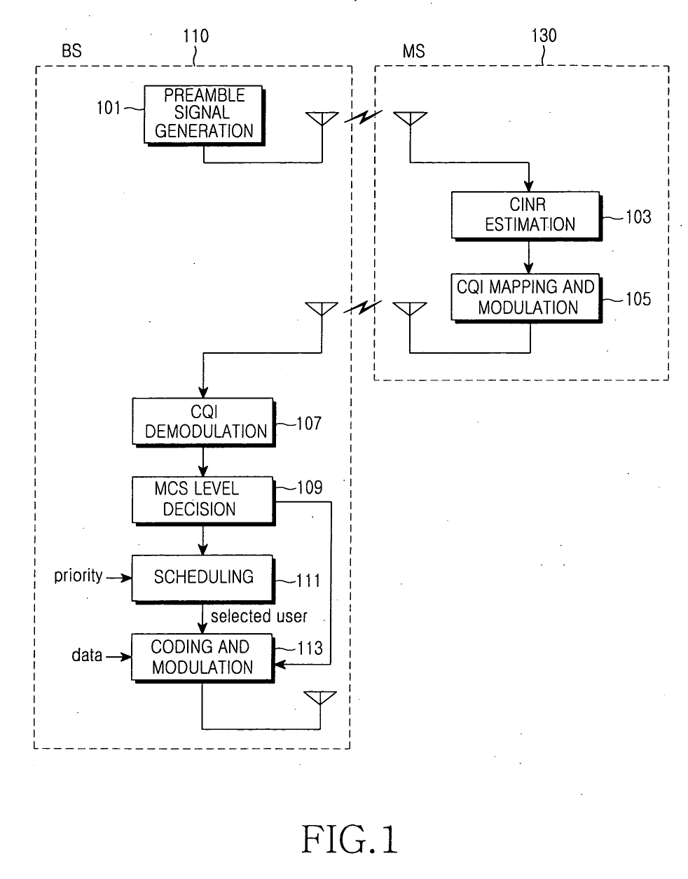

FIG. 2 is a diagram illustrating a concept of a link table according to FIG 1;

FIG. 3 is a diagram illustrating a conceptual link table based on moving velocity of an MS in a BWA communication system according to the present invention;

FIG. 4 is a diagram schematically illustrating a process of applying an AMC technique through link table application depending on velocity of an MS according to the present invention;

FIG. 5 is a flowchart illustrating a method for selecting a link table according to the present invention; and

FIG. 6 is a diagram illustrating a CQI difference versus a velocity of an MS according to the present invention.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

Before a detailed description of the present invention is given, it should be noted that the present invention provides an Adaptive Modulation and Coding (AMC) technique in an Orthogonal Frequency Division Multiple Access (OFDMA)-based Broadband Wireless Access (BWA) communication system.

In particular, the present invention provides an AMC technique taking the moving velocity of a mobile station (MS) into account in the BWA communication system. In addition, the present invention provides a scheme of using Channel Quality Information (CQI) in the process of determining an MCS level in the BWA communication system. Specifically, the present invention determines whether the moving velocity of each MS is high or low according to channel variation, using the channel information being fed back from each MS, and applies a different MCS level according to the moving velocity, thereby facilitating dynamic resource allocation.

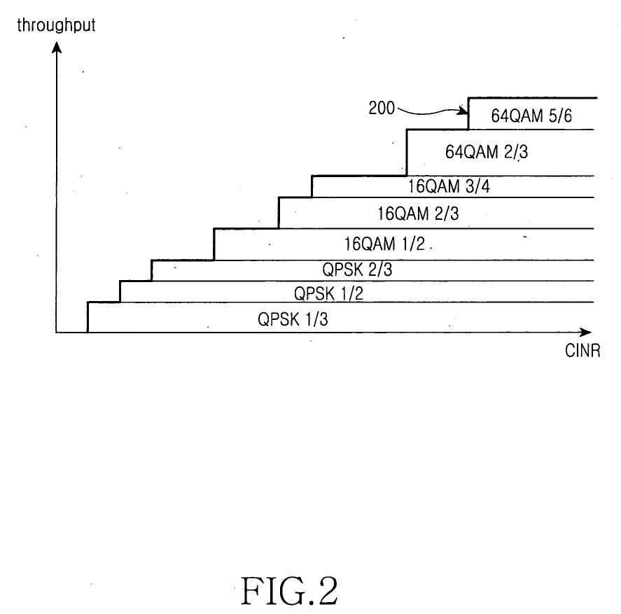

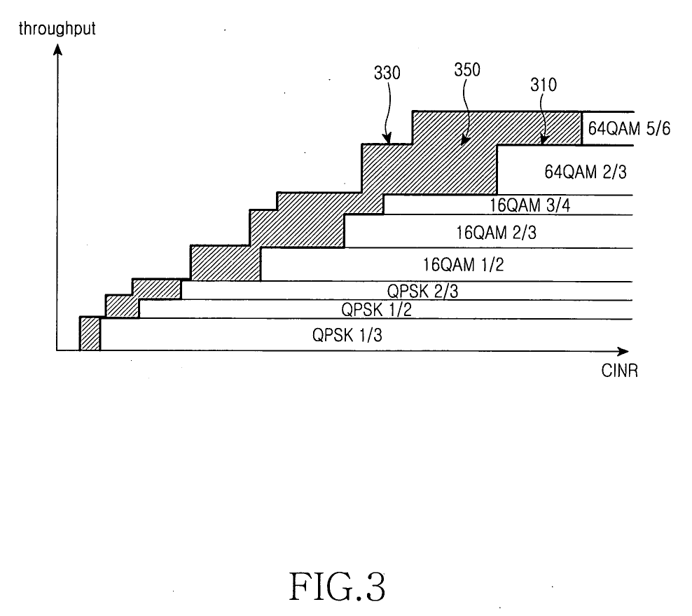

Commonly, the BWA communication system uses the AMC technique in order to acquire the high data throughput and high data quality. A link table, which is a Carrier-to-Interference and Noise Ratio (CINR)-based MCS level mapping function described in FIG. 2, is used to apply the AMC technique. The link table used for acquiring both the high throughput and the high data quality differs according to velocity of each MS, and a description thereof will be made herein below with reference to FIG. 3.

Referring to FIG. 3, the inner line 310 represents a CINR-throughput characteristic of a low-velocity MS, and the outer line 330 represents a CINR-throughput characteristic of a high-velocity MS.

In FIG. 3as the link performance 330 for the high-velocity MS suffers higher degradation compared with link performance 310 for the low-velocity MS, link 330 then needs a higher CINR for each individual MCS level. Therefore, as shown in FIG. 3, compared with the low-velocity MS, the high-velocity MS whose entire throughput is degraded controls the link table.

In addition, in the case where the link table for the low-velocity MS is applied to the system, if the high-velocity MS accesses the system, an MCS level incapable of guaranteeing the data quality will be transmitted, causing a data loss corresponding to the hatched area 350 between the boundary line 310 and the boundary line 330.

Conversely, in the case where the link table for the high-velocity MS is applied to the system, if the low-velocity MS accesses the system, the data quality can be maintained, but there is a loss of the opportunity to obtain the throughput corresponding to the hatched area 350 between the boundary line 310 and the boundary line 330.

Therefore, the present invention provides a scheme for estimating the moving velocity of each MS and applying a link table accordingly. With reference to the accompanying drawings, the description will now be made of the present invention.

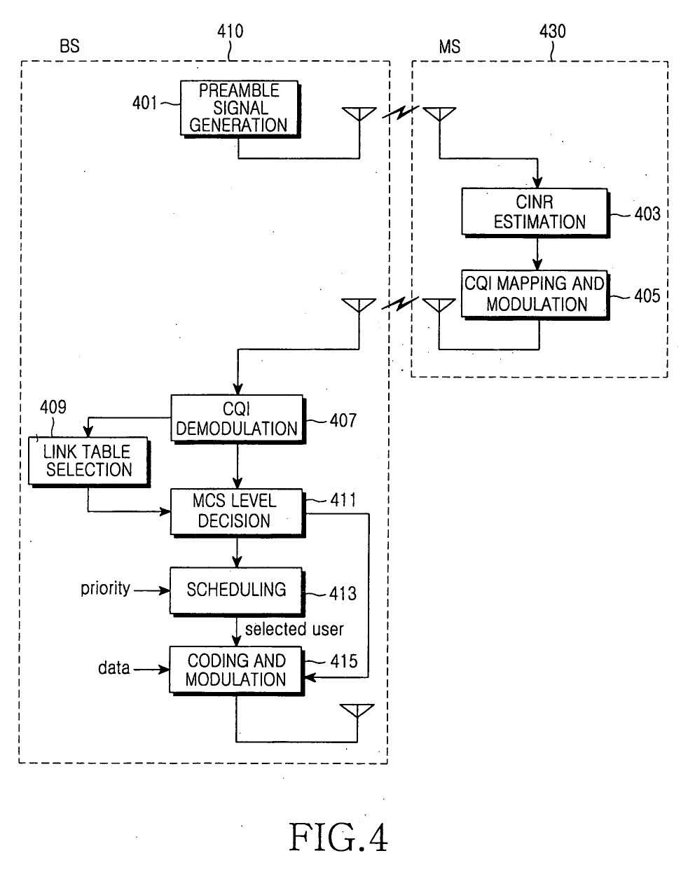

Referring to FIG. 4, a BS 410 generates a preamble signal to be transmitted to an MS 430 in step 401. Thereafter, the BS 410 transmits the generated preamble signal to the MS 430 for a first symbol of a downlink frame.

The MS 430 receiving the downlink frame estimates a received CINR from the preamble signal in step 403. Subsequently, the MS 430 maps/modulates the estimated received CINR to a CQI value in step 405. Thereafter, the MS 430 transmits the mapped CQI value to the BS 410 for the first three symbols of an uplink frame.

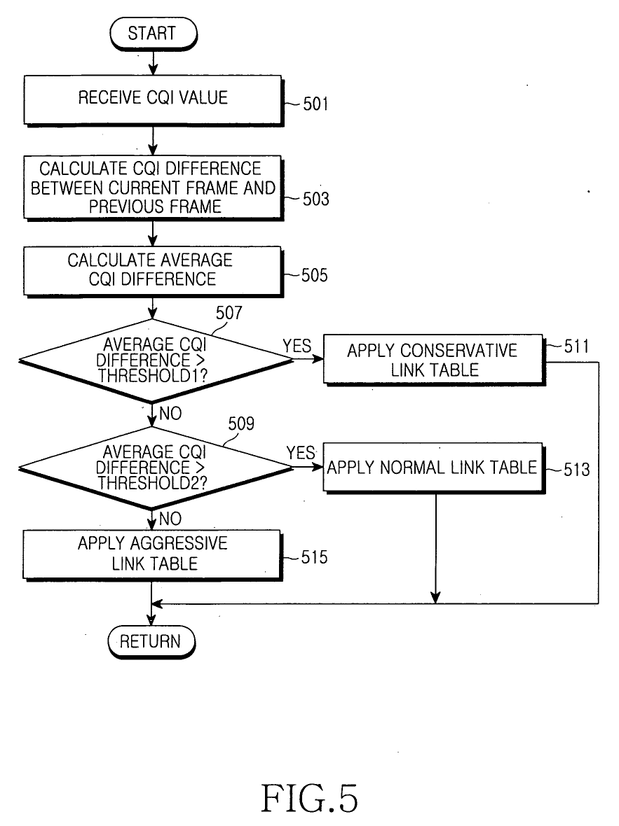

Then the BS 410 demodulates the CQI value received from the MS 430 in step 407. Thereafter, the BS 410 checks for variation in the CQI through the CQI demodulation, and selects a link table corresponding to the variation in step 409. A process of selecting the link table will be described in detail herein below with reference to FIG. 5.

Thereafter, the BS 410 determines an MCS level matched to a CQI value of each MS using the selected link table in step 411. An exemplary link table based on velocity of the MS has been shown in FIG. 3.

Next, the BS 410 selects a corresponding MS to which it will transmit data, according to a predetermined scheduling algorithm in step 413. Subsequently, after selecting a particular MS through the scheduling algorithm, the BS 410 transmits data to the selected MS using the modulation scheme and coding rate corresponding to the MCS level in step 415.

With reference to FIG. 5, a detailed description will now be made of a method for selecting a link table according to the present invention.

Referring to FIG. 5, if an instantaneous CQI value is received in step 501 (or in step 407 of FIG. 4), the BS 410 proceeds to step 503 where it calculates the difference between the received instantaneous CQI value and an instantaneous CQI value received in a previous frame, i.e. an instantaneous CQI difference CQI_diff[k], and then proceeds to step 505. The CQI difference CQI_diff[k] can be expressed as Equation (1):
CQI_diff[k]=|CQI[k]−CQI[k−1]| (1)

In Equation (1), CQI[k] denotes an instantaneous CQI value received from the MS in the current frame, CQI[k−1] denotes an instantaneous CQI value received from the MS in the previous frame, and CQI_diff[k] denotes a difference between the instantaneous CQI value received from the MS in the current frame and the instantaneous CQI value received from the MS in the previous frame. The CQI values received from the MS are sequentially accumulated in a specific storage, for example, a memory. Therefore, in step 503, if there is a CQI value received in the current frame, the BS 410 reads the CQI value received in the previous frame from the memory, and performs the process of Equation (1).

Next, in step 505, the BS 410 calculates an average CQI difference AVG_CQI_diff[k] using the instantaneous CQI difference CQI_diff[k] calculated in step 503, and then proceeds to step 507. The average CQI difference AVG_CQI_diff[k] can be expressed as Equation (2)
AVG_{—}CQI_diff[k]=(1−T)AVG_{—}CQI_diff[k−1]+T·CQI_diff[k] (2)

In Equation (2), AVG_CQI_diff[k−1] denotes an average CQI difference calculated from the MS in the previous frame, CQI_diff[k] denotes the instantaneous CQI difference, T denotes an Infinite Impulse Response (IIR) coefficient, and AVG_CQI_diff[k] denotes an average CQI difference. The average CQI difference AVG_CQI_diff[k−1] received in the previous frame is read from the memory, and the calculated average CQI differences AVG_CQI_diff[k] are sequentially accumulated in the memory.

Next, in steps 507 and 509, the BS 410 compares the average CQI difference with thresholds (threshold1 and threshold2) previously set in the system, to estimate a velocity of the MS. The present invention divides the velocity of the MS into a high velocity, an intermediate velocity, and a low velocity, and sets two thresholds for the velocity division. However, the present invention is not limited to this. That is, the present invention can divide the velocity of the MS into two velocities of a high velocity and a low velocity, or finely divide the velocity of the MS into three velocities. In addition, the present invention can set one threshold taking the system situation into consideration, or set a plurality of fine thresholds according to the divided velocities of the MS.

If it is determined through steps 507 and 509 that the average CQI difference is greater than or equal to a predetermined level, i.e. the first threshold set in the system, the BS 410 proceeds to step 511, considering that the corresponding MS as a high-velocity MS. In step 511, the BS 410 selects a conservative link table for the high-velocity MS.

However, if it is determined through steps 507 and 509 that the average CQI difference is an intermediate level, i.e. is less than the first threshold and greater than the second threshold, the BS 410 proceeds to step 513, considering that the corresponding MS is an intermediate-velocity MS. In step 513, the BS 410 selects a normal link table for the intermediate-velocity MS.

Further, if it is determined through steps 507 and 509 that the average CQI difference is less than or equal to a predetermined level, i.e. is less than the first threshold and less than or equal to the second threshold, the BS 410 proceeds to step 515, considering that the corresponding MS is a low-velocity MS. In step 515, the BS 410 selects an aggressive link table for the low-velocity MS.

A summary of steps 507 to 515 can be expressed as Equation (3):
if AVG_{—}CQI_diff[k]>Threshold1 conservative link table
else if AVG_{—}CQI_diff[k]>Threshold2 normal link table
else aggressive link table (3)

After selecting a specific link table through the foregoing procedure, the BS 410, as described in FIG. 4, determines an MCS level for each individual MS based on a received CINR using the selected link-table, selects an MS according to a specific scheduling algorithm set in the system, applies a modulation scheme and a coding rate corresponding to the MCS level to the selected MS, and then transmits data to the MS.

As another example, it is also possible to determine a link table by storing one link table and adjusting a difference between MCS levels or a threshold by a predetermined value according to the velocity of the MS, instead of the process of selecting a link table according to the velocity of the MS. That is, an MCS level of the MS can be determined by storing one link table, which is an MCS level decision criterion based on a CINR value, depending on a predetermined velocity of the MS, and adjusting a CINR step size of the one link table, which is the MCS level decision criterion, according to the measured velocity of the MS. Especially, the MCS level of the MS can be determined by storing one link table. In addition, there is another possible method for defining the link table as a function, and determining a slope or a pattern of the link table function according to the velocity of the MS.

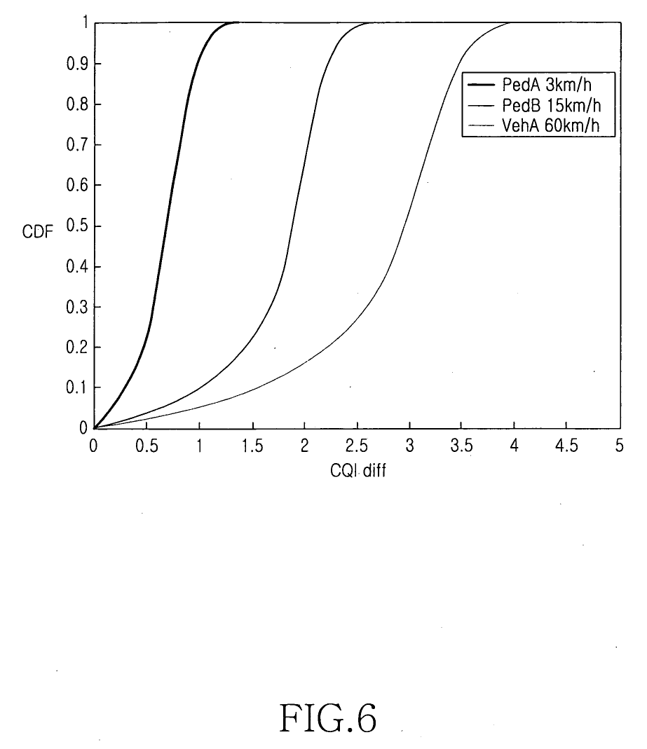

Commonly, in the BWA communication system, each MS transmits CQI information to the BS for AMC application. The CQI information of each MS is mapped to a received CINR, and as shown in FIG. 6, is in linear proportion to a variation in the CINR.

It can be understood from FIG. 6 that every frame suffers a large change for an instantaneous received CINR estimated by a high-velocity MS, and a CQI value received at the BS also suffers a large change as well. In addition, it can be noted that a frame rarely suffers a change for an instantaneous received CINR estimated by a low-velocity MS, and a CQI value received at the BS also rarely suffers a change.

As can be understood from the foregoing description, the present invention can estimate a velocity of the MS by estimating a difference in the CQI value transmitted by the MS. That is, for the MS whose CQI difference is greater than or equal to a predetermined reference, the invention applies the conservative link table, considering that the MS is a high-velocity MS, and for the MS whose CQI difference is less than or equal to a predetermined reference, the invention applies the aggressive link table, considering that the MS is a low-velocity MS, thereby contributing to improved throughput and data quality.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A method for transmitting data based on an Adaptive Modulation and Coding (AMC) technique in a Broadband Wireless Access (BWA) communication system, the method comprising the steps of:
measuring a channel quality information (CQI) difference for mobile station(MS) according to channel information fed back from the MS;
estimating a moving velocity of each of the MS according to the CQI difference;
selecting a mapping table for each individual MS taking into account the estimated velocity of the MS; and
transmitting data to a corresponding MS by applying an appropriate modulation scheme and coding rateorresponding to the mapping table.

2. The method of claim 1, wherein the step of estimating a moving velocity of each MS according to the CQI difference comprises estimating a velocity of a specific MS depending on the CQI difference corresponding to changes in a Carrier-to-Interference and Noise Ratio (CINR).

3. The method of claim 1, wherein the mapping table is a link table having a Modulation and Coding Selection (MC) level mapping function according to a CINR.

4. The method of claim 1, wherein the step of selecting a mapping table comprises:
calculating a CQI difference using the CQI value upon receipt of a CQI value of a specific MS;
calculating an average CQI difference using the CQI difference;
comparing the average CQI difference with a specific threshold set in the system to estimate a velocity of the MS; and
selecting a mapping table corresponding to the estimated velocity of the MS.

5. The method of claim 4, wherein the CQI difference is calculated using a difference between the CQI value and a previous CQI value received from the MS in a previous frame.

6. The method of claim 4, wherein the average CQI difference is calculated by
AVG_{—}CQI_diff[k]=(1−T)AVG_{—}CQI_diff[k−1]+T·CQI_diff[k]
where AVG_CQI_diff[k−1] denotes an average CQI difference calculated from the MS in the previous frame, CQI_diff[k] denotes the CQI difference, T denotes an Infinite Impulse Response (IIR) coefficient, and AVG_CQI_diff[k] denotes an average CQI difference.

7. The method of claim 4, wherein the step of selecting a mapping table comprises:
selecting a consenative link table to be allocated to the high-velocity MS if the MS is determined as a high-velocity MS as a result of comparing the CQI difference of the MS with the threshold set in the system; and

8. The method of claim 4, wherein the step of selecting a mapping table comprises:
selecting a normal link table to be allocated to the intermediate-velocity MS if the MS is determined as an intermediate-velocity MS as a result of comparing the CQI difference of the MS with the threshold set in the system.

9. The method of claim 4, wherein the step of selecting a mapping table comprises:
selecting an aggressive link table to be allocated to the low-velocity MS if the MS is determined as a low-velocity MS as a result of comparing the CQI difference of the MS with the threshold set in the system.

10. The method of claim 4, further comprising:
determining an MCS level for each individual MS according to a received CINR using the selected mapping table after selecting the mapping table;
selecting a corresponding MS according to a specific scheduling algorithm set in the system; and
transmitting data to the selected MS by applying a modulation scheme and a coding rate corresponding to the MCS level.

11. A system for transmitting data based on an Adaptive Modulation and Coding (AMC) technique in a Broadband Wireless Access (BWA) communication system, the system comprising:
a mobile station (MS) for feeding back its own channel quality information (CQI), transmitting and receiving data using a modulation scheme and a coding rate allocated according to its own velocity; and
a base station (BS) for measuring a difference of the CQI, estimating a moving velocity of each MS according to the CQI difference, and exchanging data with the MS using a modulation scheme and a coding rate of a mapping table corresponding to the velocity of the M.

12. The system of claim 11, wherein the BS's estimation comprises estimating a velocity of a specific MS depending on the CQI difference corresponding to a change in a Carrier-to-Interference and Noise Ratio (CINR).

13. The system of claim 11, wherein the mapping table is a link table having a Modulation and Coding Selection (MCS) level mapping function according to a CINR.

14. The system of claim 11, wherein the BS calculates a CQI difference using the CQI value upon receipt of a CQI value of the MS, calculates an average CQI difference using the CQI difference, compares the average CQI difference with a specific threshold set in the system to estimate a velocity of the MS, and selects a mapping table the estimated velocity of the MS.

15. The system of claim 14, wherein the BS calculates the CQI difference using a difference between the CQI value and a previous CQI value received from the MS.

16. The system of claim 14, wherein the BS calculates the average CQI difference according to:
AVG_{—}CQI_diff[k]=(1−T)AVG_{—}CQI_diff[k−1]+T·CQI_diff[k]
where AVG_CQI_diff[k−1] denotes an average CQI difference calculated from the MS in the previous frame, CQI_diff[k] denotes the CQI difference, T denotes an Infinite Impulse Response (IIR) coefficient, and AVG_CQI_diff[k] denotes an average CQI difference.

17. The system of claim 14, wherein if the MS is determined as a high-velocity MS as a result of comparing the CQI difference of the MS with the threshold set in the system, the BS selects a conservative link table to be allocated to the high-velocity MS.

18. The system of claim 14, wherein if the MS is determined as an intermediate-velocity MS as a result of comparing the CQI difference of the MS with the threshold set in the system, the BS selects a normal link table to be allocated to the intermediate-velocity MS.

19. The system of claim 14, wherein if the MS is determined as a low-velocity MS as a result of comparing the CQI difference of the MS with the threshold set in the system, the BS selects an aggressive link table to be allocated to the low-velocity MS.

20. The system of claim 14, wherein after selecting the mapping table, the BS determines an MCS level for each individual MS according to a received CINR using the selected mapping table, selects a corresponding MS according to a specific scheduling algorithm set in the system, and transmits data to the selected MS by applying a modulation scheme and a coding rate corresponding to the MCS level.

21. A method for transmitting data based on an Adaptive Modulation and Coding (AMC) technique in a Broadband Wireless Access (BWA) communication system, the method comprising the steps of:
measuring a channel quality information (CQI) difference for a mobile stations (MS) according to channel information fed back from the MS;
estimating a moving velocity of the MS according to the CQI difference;
determining a modulation scheme and coding rate of the MS according to the estimated velocity of the MS; and
transmitting data to the corresponding MS by applying the determined modulation scheme and coding rate.

22. The method of claim 21, wherein the step of determining a modulation scheme and coding rate comprises selecting a mapping table for the MS according to the estimated velocity of the MS.

23. The method of claim 22, wherein the mapping table is a link table having a Modulation and Coding Selection (MCS) level mapping function

24. The method of claim 21, wherein the step of determining a modulation scheme and coding rate comprises the steps of:
adjusting threshold of CINR for the modulation scheme and coding rate according the estimated velocity of the MS; and
comparing the CINR of the MS with the adjusted threshold of CINR.

25. The method of claim 24, wherein the step of adjusting threshold of CINR comprises adjusting step size of CINR in a link table which mapping a CINR with a modulation scheme and coding rate according to the velocity of the MS.

26. The method of claim 24, wherein the step of adjusting threshold of CINR comprises inputting the velocity of the MS to function for mapping a CINR with a modulation scheme and coding rate.
